(19) United States
(12) Patent Application Publication
(10) Pub. No.: US 2009/0119258 A1
(43) Pub. Date: May 7, 2009

(54) SYSTEM AND METHOD FOR CONTENT RANKING AND REVIEWER SELECTION

(76) Inventor: William Petty, San Francisco, CA (US)

Correspondence Address: PERKINS COIE LLP, P.O. BOX 1208, SEATTLE, WA, 98111-1208, US

(21) Appl. No.: 12/038,989

(22) Filed: Feb. 28, 2008

Related U.S. Application Data
(60) Provisional application No. 60/985,292, filed on Nov. 5, 2007.

(51) Int. Cl. G06F 17/30; G06F 7/10

(52) U.S. Cl. 707/3; 707/104.1; 707/E17.009

(57) ABSTRACT

Systems and methods for content ranking and reviewer selection are disclosed. In one aspect of the present disclosure, a method of content review includes receiving submitted content and identifying reviewers based on a set of criteria. The submitted content can be presented to the reviewers and ratings of the submitted content can be received from the reviewers. In another aspect of the present disclosure, a method of rating reviewers includes providing content to a reviewer to be scored no the scale. The score provided by the reviewer user is recorded and the amount of time for the reviewer to score the content is tracked. Reviewer user rating can be adjusted based on the amount of review time.

### CROSS-REFERENCE TO RELATED APPLICATIONS

This application is a Non-Provisional of Provisional 35 U.S.C. § 119(e) application 60/985,292 entitled “System and Method for Ranking Content Submissions to Community Internet Sites” filed on Nov. 5, 2007 and is hereby incorporated herein by reference.

### BACKGROUND

Community Internet sites accept user submitted content that is shared with other site users. However, popular sites may receive more submissions than can be logically presented on a user interface for ease of access. The sites have a need to rank these submissions by quality such that they can be presented to users in a more user friendly manner.

Content submission may be ranked in a number of ways, which may be used singly or in combination with one another. For example, content submission can be managed by a paid editorial staff designated to perform this function. However, maintenance of user content by an editorial staff may be at odds with the evolving Internet business model in which content is typically user generated and edited.

Content submissions may be additionally ranked through the popularity of individual content submissions as evidenced by the relative number of viewings (or ‘hits’) of the submissions. Further, submissions can be explicitly ranked by users in the course of site explorations. However, users tend to have a preference to view and/or rate content of interest or content come upon during web browsing and good content may be overlooked.

Furthermore, popularity ratings as tracked by the number of click-throughs and voluntary user ratings may be heavily influenced by the Internet community (e.g., bloggers, popular social networking professionals, writers for mainstream media, advertisements, and public relations professionals) who may significantly affect rankings through their recommendations and actions. The contributor of content high in quality without community endorsement may find that content unrecognized or ranked lower than inferior submissions.

### SUMMARY OF THE DESCRIPTION

Systems and methods for content ranking and reviewer selection are described here. Some embodiments of the present disclosure are summarized in this section.

One aspect of the present disclosure includes a method, which may be implemented on a system, of, content review. The method can include, receiving submitted content, identifying a plurality of reviewers based on a set of criteria, presenting the submitted content to the plurality of reviewers, receiving a set of ratings of the submitted content from a set of the plurality of reviewers, and/or generating a cumulative rating from the set of ratings. The set of criteria can include one or more of, ratings, topics of preference, and/or topics of expertise of a set of reviewers from which the plurality of reviewers is to be selected.

One embodiment further includes determining whether the cumulative rating exceeds a first predetermined threshold and/or presenting the submitted content to an additional set of reviewers responsive to determining that the cumulative rating exceeds the first predetermined threshold.

One embodiment further includes, determining that the submitted content has been received by a predetermined number of reviewers, re-computing the cumulative rating based on ratings submitted by the predetermined number of reviewers, determining that the cumulative rating of the submitted content exceeds a second predetermined threshold, and/or providing access to the submitted content. The plurality of reviewers can be selected based on a ranking associated with each of the plurality of reviewers. The set of criteria typically includes the ranking associated with each of the plurality of reviewers.

One embodiment includes, presenting the particular reviewer with another submitted content having a cumulative rating above the first predetermined threshold responsive to determining that a particular reviewer of the plurality of reviewers has rated a particular submitted content below the first predetermined threshold. The submitted content can include, at least one of, textual content, audio content, image content, and/or video content.

A further aspect of the present disclosure includes a method, which may be implemented on a system, of, rating a set of reviewers. One embodiment includes, providing content to a reviewer user to be scored on a scale, recording a score provided by the reviewer user, tracking an amount of time for the reviewer user to score the content, and/or adjusting a rating of the reviewer user based on the amount of time.

One embodiment includes, further providing the reviewer user with a set of content to score on the scale, determining a rate of responsiveness of the reviewer user based on a number of a reviewed set of content reviewed and a number of a provided set of content, recording a set of scores provided by the reviewer user associated with the reviewed set of content, and/or adjusting the rating of the reviewer user based on the rate of responsiveness. The rate of responsiveness is the ratio of the number of the reviewed set of content and the number of the provided set of content. The rating of the reviewer may be increased user when the rate of responsiveness is above a predetermined threshold. One embodiment includes, tracking a set of review time for the reviewer user to review the reviewed set of content and/or adjusting the rating based on the set of review time.

One embodiment further includes, providing the set of reviewer users with the content to be scored on a scale, recording a set of content scores provided by the set of reviewer users associated with the content, determining statistical attributes associated with the set of content scores, and/or adjusting a set of ratings associated with the set of reviewer users based on the statistical attributes. The statistical attributes comprises one or more of a mean and a standard deviation of the set of content scores. In one embodiment, the rating of a reviewer user of the set of reviewer users is decreased when a content score of the set of content scores provided by reviewer user exceeds the standard deviation.

Another aspect of the present disclosure includes a method, which may be implemented on a system, of, selecting reviewers to rate a submission. One embodiment includes, querying a user to determine whether the user is willing to review a submission, assigning higher review priority to a set of submissions received after a particular time, randomly selecting a submission of the set of submissions, identifying a set of reviewers that have reviewed the submission, and/or determining a demographic association of each of the set of reviewers. Statistical attributes of the demographic association of the set of reviewers may be determined. In one embodiment, another reviewer that is substantially demographically consistent with the demographic association of the set of reviewers to review the submission is selected.

One embodiment includes, determining a subject matter for which the submission is relevant, identifying an expert reviewer having expertise in the subject matter, and/or presenting the expert reviewer with the submission to be reviewed.

One aspect of the present disclosure includes a system including, a user database to store user information of a set of users, a content database to store a plurality of content submissions, a selection module to select a user from the set of users to review a particular content submission of the plurality of content submissions, a review module to review the set of users, and/or a ranking module to rank the plurality of content submissions based on user ratings submitted by the set of users.

One embodiment of the system includes a timing module to determine an amount of time for the user to review the particular content submission.

The present disclosure includes methods and systems which perform these methods, including processing systems which perform these methods, and computer readable media which when executed on processing systems cause the systems to perform these methods.

Other features of the present disclosure will be apparent from the accompanying drawings and from the detailed description which follows.

### BRIEF DESCRIPTION OF THE DRAWINGS

FIG. 1 illustrates a block diagram of a plurality of client devices, web application servers, and a content ranking server coupled via a network, according to one embodiment.

FIG. 2 depicts a block diagram illustrating an example system for ranking content and selecting reviewers, the system to include a content ranking server coupled to a user database and/or a content database, according to one embodiment.

FIG. 3A depicts a block diagram illustrating an example of a user database that stores user profile information, user content, and/or reviewer ratings, according to one embodiment.

FIG. 3B depicts a block diagram illustrating an example of a content database that receives submitted content, according to one embodiment.

FIG. 4A depicts a flow diagram illustrating an example process of performing a first pass review to preliminarily screen submitted content, according to one embodiment.

FIG. 4B depicts a flow diagram illustrating an example process of performing a second pass review to determine publication of submitted content, according to one embodiment.

FIG. 5A depicts a flow diagram illustrating an example process of adjusting the rating of a reviewer user, according to one embodiment.

FIG. 5B depicts a flow diagram illustrating another example process of adjusting the rating of a reviewer user, according to one embodiment.

FIG. 5C depicts a flow diagram illustrating a further example process of adjusting the rating of a reviewer user, according to one embodiment.

FIG. 6 depicts a flow diagram illustrating an example process of selecting a reviewer to rate a content submission, according to one embodiment.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Embodiments of the present disclosure include systems and methods for content ranking and selection of the reviewers for substantially unbiased and objective ranking.

In one aspect, the present disclosure relates to ranking content submissions for content hosts based on user ratings and/or reviews.

The content host may be a third party host that requests the host system to rank a predetermined set of user submitted content. The host system can also rank content directly submitted by users. Each piece of content receives initial ratings in a first pass review process from a number of reviewers. The reviewers for each piece of content are typically selected to prevent biases and preferences. Timing considerations are also factored into the reviewer selection process.

A cumulative rating can be determined from the ratings received during the first pass review. The cumulative rating determines whether the content qualifies for a second review process. Typically the cumulative score of a particular piece of content needs to exceed some predetermined threshold to qualify for the second pass review. The cumulative score is generated from at least a portion of the rankings received from the reviewers. In addition, ratings of the reviewers may affect the cumulative score as well. Content that does not qualify for the second pass review process may not be published or may be provided to a third party (e.g., end user, third party content host, etc.) as having an ‘unranked’ status. In some instances, content disqualified after the first pass review are discarded from the system.

During the second pass review, additional reviewers are identified to rate the piece of content. For content to be ranked and/or otherwise published, a cumulative rating over a particular threshold ought to be received based on reviews from a predetermined number of reviewers. The number of reviews and/or the score threshold can be adjusted as suitable. The number of reviews required and the score threshold may vary based on the type of content and the subject matter relating to the content. The number of required reviews and/or score thresholds may also be customer specifiable (e.g., specified by end users and/or third party content hosts). Other factors that can affect the suitable number of reviews and score threshold are contemplated and are considered to be within the scope of this disclosure.

After the second pass review, content ranking can be provided to the requestor (e.g., end user, third party content hosts). Additionally, ranked content that were directly submitted to the host server can be licensed out to third party content hosts. In some instances, additional information related to the ranking (e.g., number of reviewers, scores granted by each reviewer, scores of competing content, etc.) can be provided to the requestor (e.g., customer) with or without a fee.

In an alternative example, there is an initial pass of about 5 reviews, and then there is a further process of bringing the final number of reviews in line with an ideal number of reviews for each rating level. Each time a review is done, the average rating for the piece is adjusted to include the information from the last review. Based on the new average rating, the system asks if a sufficient number of reviews have been done. If so, there are no more reviews; if not, there are more reviews until the number of reviews is in line with the average ranking of the piece.

An example of the relationship between current average rating, and final number of desired reviews (for a reviewing scale from 1 to 100) is illustrated.

Assuming that the number of Desired Reviews equals (Current Average Rating divided by 10) cubed, content with an average reviewer rating of 40 would be reviewed approximately 64 times, and content with an average reviewer rating of 90 would be reviewed approximately 729 times. If the scale is logarithmic, there may also be a maximum number of reviews, beyond which no more are necessary. Therefore, higher ranked pieces get ranked many more times than lower ranked ones, on a logarithmic scale such that the ratings of good pieces are highly refined. In one embodiment, no content is unpublished, but the finely tuned rankings are used as the guide to serving up content, and users can browse all pieces from the highest ranked to the lowest (if they want), according to user ranking.

In one aspect, the present disclosure relates to rating reviewers and selecting reviewers based on, for example, reviewer behavior.

One of the factors involved in selecting reviewers is based on ratings of the reviewers. Reviewer rating (e.g., quality of a reviewer's rating) is a crucial variable in the equation to ensuring efficacy and quality of reviews for user submitted content. Reviewer rating can provide as an indicator of multiple facets of a reviewer user's rating behavior, including, but not limited to, the merits of given reviews, consistency of a reviewer user's reviewing habits, responsiveness of a reviewer, the amount of review time a reviewer needs, etc.

Therefore, the host system tracks these metrics and rates the reviewers based on their rating behavior. Various statistical attributes (e.g., mean, variance, regression, correlation) for the collected data can be obtained to facilitate reviewer ranking. For example, responsiveness is determined by computing how much content the reviewer reviews versus the number of requests were received by the user. Higher responsiveness typically increases the rating of a reviewer user. Review time can be used as an indicator of the level of meticulousness of the reviewer in reviewing the content. Additional metrics are contemplated and are utilizable in determining reviewer rating/quality and are considered to be within the novel scope of this disclosure.

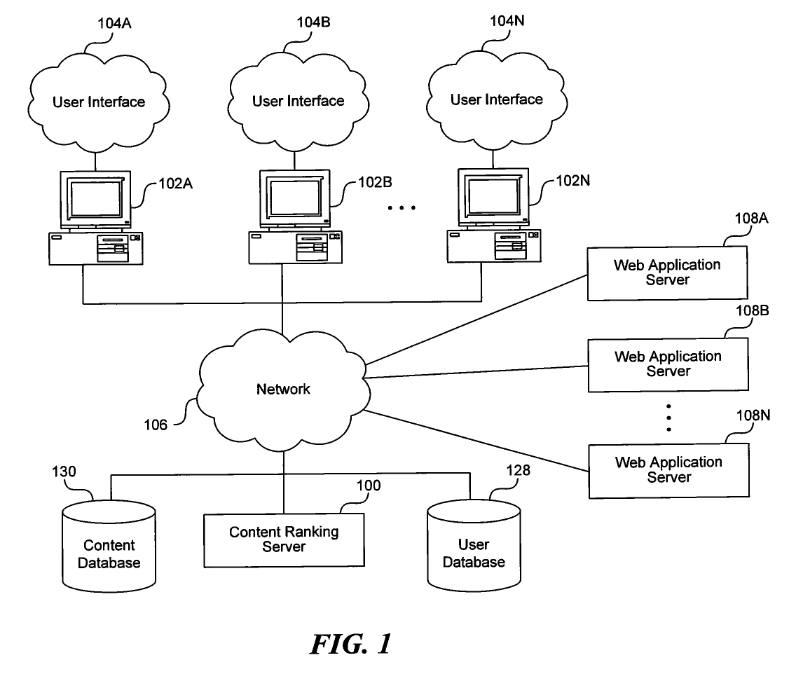

FIG. 1 illustrates a block diagram of a plurality of client devices 102A-N, web application servers 108A-N, and a content ranking server 100 coupled via a network 106, according to one embodiment.

The plurality of client devices 102A-N can be any system and/or device, and/or any combination of devices/systems that is able to establish a connection with another device, a server and/or other systems. The client devices 102A-N typically include display or other output functionalities to present data exchanged between the devices to a user. For example, the client devices and content providers can be, but are not limited to, a server desktop, a desktop computer, a computer cluster, a mobile computing device such as a notebook, a laptop computer, a handheld computer, a mobile phone, a smart phone, a PDA, a Blackberry device, a Treo, and/or an iPhone, etc. In one embodiment, the client devices 102A-N are coupled to a network 106. In some embodiments, the client devices may be directly connected to one another.

The network 106, over which the client devices 102A-N may be a telephonic network, an open network, such as the Internet, or a private network, such as an intranet and/or the extranet. For example, the Internet can provide file transfer, remote log in, email, news, RSS, and other services through any known or convenient protocol, such as, but is not limited to the TCP/IP protocol, Open System Interconnections (OSI), FTP, UPnP, iSCSI, NSF, ISDN, PDH, RS-232, SDH, SONET, etc.

The network 106 can be any collection of distinct networks operating wholly or partially in conjunction to provide connectivity to the client devices, host server, and may appear as one or more networks to the serviced systems and devices. In one embodiment, communications to and from the client devices 102A-N can be achieved by, an open network, such as the Internet, or a private network, such as an intranet and/or the extranet. In one embodiment, communications can be achieved by a secure communications protocol, such as secure sockets layer (SSL), or transport layer security (TLS).

In addition, communications can be achieved via one or more wireless networks, such as, but is not limited to, one or more of a Local Area Network (LAN), Wireless Local Area Network (WLAN), a Personal area network (PAN), a Campus area network (CAN), a Metropolitan area network (MAN), a Wide area network (WAN), a Wireless wide area network (WWAN), Global System for Mobile Communications (GSM), Personal Communications Service (PCS), Digital Advanced Mobile Phone Service (D-Amps), Bluetooth, Wi-Fi, Fixed Wireless Data, 2G, 2.5G, 3G networks, enhanced data rates for GSM evolution (EDGE), General packet radio service (GPRS), enhanced GPRS, messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless data networks or messaging protocols.

The client devices 102A-N can be coupled to the network (e.g., Internet) via a dial-up connection, a digital subscriber loop (DSL, ADSL), cable modem, and/or other types of connection. Thus, the client devices 102A-N can communicate with remote servers (e.g., web server, host server, mail server, instant messaging server) that provide access to user interfaces of the World Wide Web via a web browser, for example.

The user database 128 and content database 130 can store software, descriptive data, images, system information, drivers, and/or any other data item utilized by parts of the host server 100 for operation. The databases 128 and 130 may also store user information and user content, such as, user profile information, subscription information, audio files, and/or data related to the user content (e.g., statistical data, file attributes, timing attributes, owner of the content, etc.). The user database 128 and content database 130 may be managed by a database management system (DBMS), for example but not limited to, Oracle, DB2, Microsoft Access, Microsoft SQL Server, PostgreSQL, MySQL, FileMaker, etc.

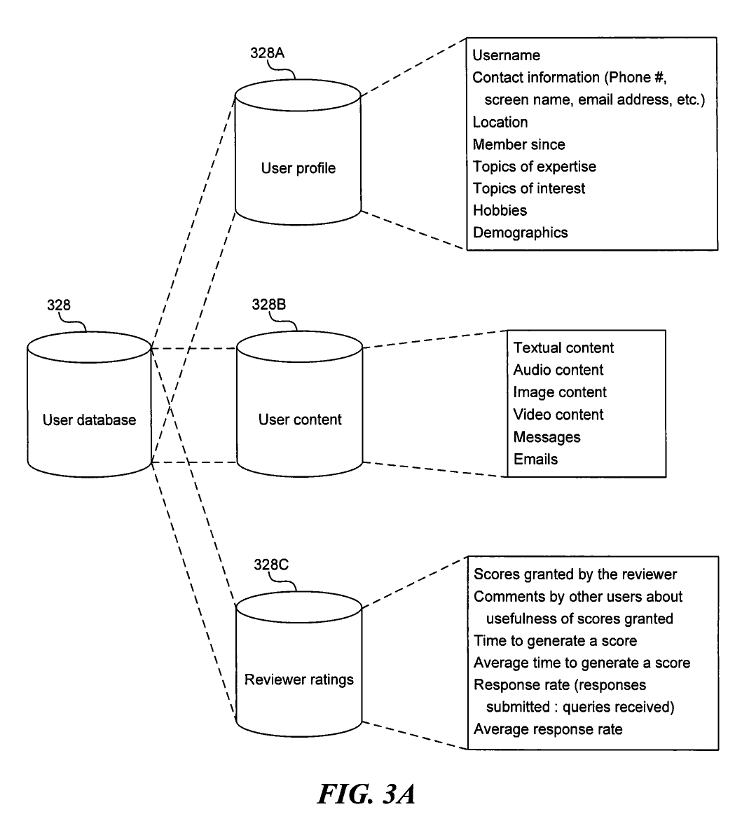

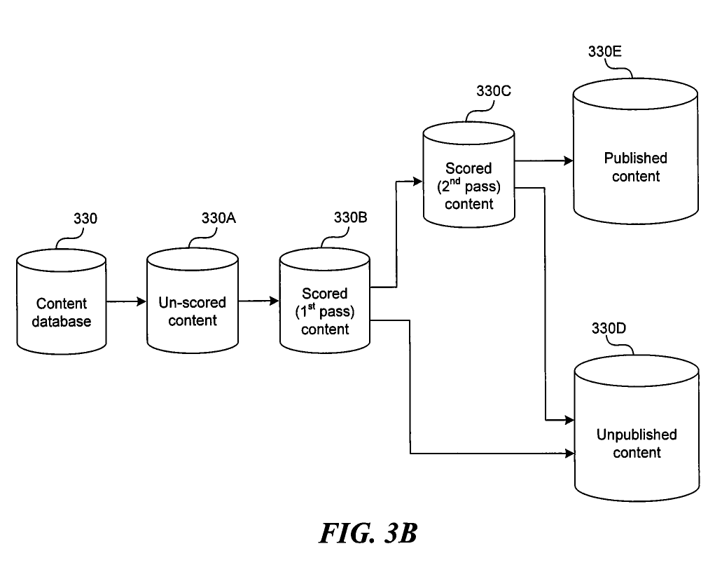

The databases 128 and 130 can be implemented via object-oriented technology and/or via text files, and can be managed by a distributed database management system, an object-oriented database management system (OODBMS) (e.g., ConceptBase, FastDB Main Memory Database Management System, JDOInstruments, ObjectDB, etc.), an object-relational database management system (ORDBMS) (e.g., Informix, OpenLink Virtuoso, VMDS, etc.), a file system, and/or any other convenient or known database management package. An example set of data to be stored in the user database 128 and content database 130 is further illustrated in FIG. 3A-3B.

The web application servers 108A-N can be any combination of software agents and/or hardware modules for providing software applications to end users, external systems and/or devices. The web application servers 108A-N can facilitate interaction and communication with the content ranking server 100, or with other related applications and/or systems. For example, the web application servers 108A-N can receive content and/or commands from the content ranking server 100. In some instances, the web application servers 108A-N, requests the content ranking server 100 to rank a set of contents. The content ranking server 100 can then provide the rankings to the web application servers 108A-N after having received user (e.g., reviewer) feedback. In some embodiments, the content ranking server 100 receives user content submissions. Web application servers 108A-N may, in this situation, request content ranked above a certain threshold from the content ranking server 100.

The web application servers 108A-N can further include any combination of software agents and/or hardware modules for accepting Hypertext Transfer Protocol (HTTP) requests from end users, external systems, and/or external client devices and responding to the request by providing the requestors with web pages, such as HTML documents and objects that can include static and/or dynamic content (e.g., via one or more supported interfaces, such as the Common Gateway Interface (CGI), Simple CGI (SCGI), PHP, JavaServer Pages (JSP), Active Server Pages (ASP), ASP.NET, etc.).

In addition, a secure connection, SSL and/or TLS can be established by the web application servers 108A-N. In some embodiments, the web application servers 108A-N renders the web pages with graphic user interfaces. The web pages provided by the web application servers 108A-N to client users/end devices enable user interface screens 104A-104N for example, to be displayed on client devices 102A-104N. In some embodiments, the web application servers 108A-N also perform authentication processes before responding to requests for resource access and data retrieval.

The content ranking server 100 is, in some embodiments, able to communicate with client devices 102A-N and/or web application servers 108A-N via the network 106. In addition, the content ranking server 100 is able to retrieve data from the user database 128 and the content database 130. In some embodiments, the content ranking server 100 is able to rank content and/or select reviewers, for example, over a network (e.g., the network 106) among various users of the client devices 102A-N.

Content submissions to be rated are typically received from users of client devices 102A-N, for example. Based on the content received, the content ranking server 100 can further select some users (e.g., users of client devices 102A-N) as reviewer users of the submitted content. Once submitted content have been disbursed to the selected reviewer users and accordingly ranked, the content ranking server 100 can, in one embodiment, provide the content that is ranked above a particular threshold to one or more of the web application servers 108A-N. The web application servers 108A-N can then provide end users (e.g., via client devices 102A-N) with access to the ranked content (e.g., articles, notes, videos, images, etc.).

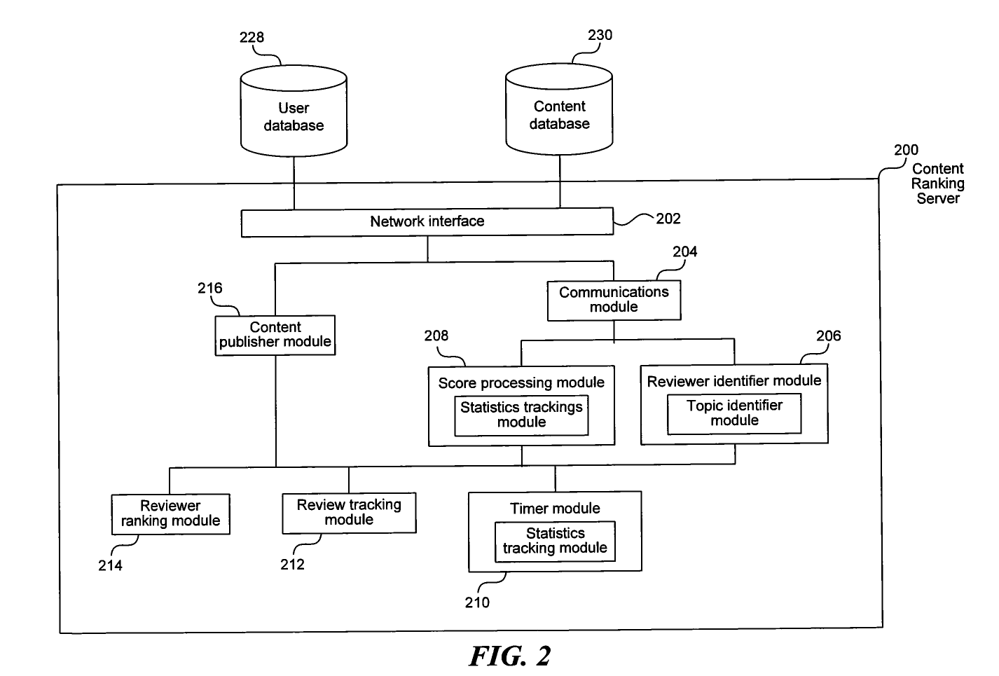

FIG. 2 depicts a block diagram illustrating a system for ranking content and selecting reviewers, the system to include a content ranking server 200 coupled to a user database 228 and/or a content database 230, according to one embodiment.

In the example of FIG. 2, the content ranking server 200 includes a network interface 202, a firewall (not shown), a communications module 204, a reviewer identifier module 206, a score processing module 208, a timing module 210, an review tracking module 212, a reviewer ranking module 214, and/or a content publisher module 216. Additional or less modules may be included. The content ranking server 200 may be communicatively coupled to the user database 228 and/or the content database 230 as illustrated in FIG. 2. In some embodiments, the user database 228 and/or the content database 230 are partially or wholly internal to the content ranking server 200.

In the example of FIG. 2, the network controller 202 can be one or more networking devices that enable the host server 200 to mediate data in a network with an entity that is external to the host server, through any known and/or convenient communications protocol supported by the host and the external entity. The network controller 202 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

A firewall, can, in some embodiments, be included to govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

Other network security functions can be performed or included in the functions of the firewall, can be, for example, but are not limited to, intrusion-prevention, intrusion detection, next-generation firewall, personal firewall, etc. without deviating from the novel art of this disclosure. In some embodiments, the functionalities of the network interface 202 and the firewall are partially or wholly combined and the functions of which can be implemented in any combination of software and/or hardware, in part or in whole.

In the example of FIG. 2, the host server 200 includes the communications module 204 or a combination of communications modules communicatively coupled to the network interface 202 to manage a one-way, two-way, and/or multi-way communication sessions over a plurality of communications protocols. In one embodiment, the communications module 204 receives data (e.g., audio data, textual data, audio files, etc.), information, commands, requests (e.g., text and/or audio-based), and/or text-based messages over a network. In one embodiment, the communications module receives communications from a network (e.g., Internet, wired and/or wireless network) initiated via a web-interface.

Since the communications module 204 is typically compatible with receiving and/or interpreting data originating from various communication protocols, the communications module 204 is able to establish parallel and/or serial communication sessions with users of remote client devices for data and command exchange (e.g., user information and/or user content).

In addition, the communications module 204 can manage log-on requests received from one or more users connecting to the content ranking server 200 to submit content, communicate with other users, review content, and/or otherwise access content. Connections are typically maintained until a user leaves the site. In some instances, authenticated sessions are managed by the communications module 204 for user logon processes.

For example, the platform may utilize a username/email and password identification method for authorizing access. The communications module 204 can gather data to determine if the user is authorized to access the system and if so, securely logs the user into the system. In other embodiments, other forms of identity authentication, include but is not limited to, security cards, digital certificates, biometric identifiers (e.g., fingerprints, retinal scans, facial scans, DNA, etc.) can be utilized and are contemplated and in accordance with this disclosure. A user may be able to specify and/or obtain a logon ID after subscribing or registering.

The communications module 204 may also establish communication sessions with third party content hosts (e.g., web application servers) to receive requests and to provide results of the ranking request. Third party content hosts can also, register with the host system for accounts to receive content ranking services. Third party content hosts can, in some instances, provide the host system with content to rank. Alternatively, third party content hosts can request content that satisfies a set of criteria from the host server. Services provided by the host server to third party content hosts may be fee-based. For example, the third party content hosts (e.g., customers) may be charged a fixed fee for ranking a certain amount of content. Additionally, the host server can license rated content submitted from users directly to the host server.

The communications module 204 can authenticate third party content hosts in a similar fashion to that of individual end users. For example, corporate accounts can be issued to third party content hosts. A corporate account with the host server, in some embodiments, enables the third party content host to make service request and/or to access other functions offered by the host server via a web-interface, including, but not limited to, content ranking, content licensing, content reviewing, obtaining detailed content reviews, obtaining reviewer information, etc.

One embodiment of the host server 200 includes a reviewer identifier module 206. The reviewer identifier module 206 can be any combination of software agents and/or hardware components able to obtain user information. User information can be obtained in real-time from user response to a query or retrieved from information stored in the user database 228. The reviewer identifier module 206 is, in most instances able to query users' willingness to participate in content reviewing. Information regarding a user's willingness to participate in content reviewing can further be updated and/or stored in the user database 228.

The reviewer identifier module 206, in one embodiment, is able to receive commands from the communications module 204. For example, the reviewer identifier module 206 receives content submissions to be reviewed. The communications module 204 can then, retrieve user information from the user database to identify users that are willing to review content as well as additional user information to identify those more suitable for particular types of content. For example, the user database 228 may store information regarding a reviewer's rating derived from a number of qualitative and quantitative factors. Reviewer ratings can be used by the communications module 204 to select suitable reviewers. Furthermore, the reviewer identifier module 206 may in most instances, be able to communicate with the reviewer ranking module 214 to obtain rating information related to reviewers.

In addition, the reviewer identifier module 206 is typically able to determine the interests and preferences of potential reviewers, either via obtaining the information from the user database 228 and/or querying the potential reviewer in real-time (or near real-time) for the information to facilitate determination of suitable reviewers. Generally, a user's specific area of expertise in the subject matter relevant to the submitted content in question typically flags the user as an ideal review candidate. However, user preferences and interests in subject matter relevant to submitted content may cause the user to be flagged as a less ideal review candidate due to assumed bias. In some instances, to reward reviewers for diligence in participation in content review, submitted content of interest to the reviewer is provided to the reviewer for rating. In one embodiment, the reviewer is offered a Boolean (yes/no) option to select whether he/she wishes to review a particular piece of content.

In some embodiments, the reviewer identifier module 206 includes a topic identifier module for analyzing document content to determine one or more relevant subject matters. Document content can be determined via one or more known and/or convenient manner, for example, via keyword search, natural language processing, machine translation, optical character recognition, information extraction, named entity recognition, etc. Identified topic can be used to locate suitable reviewers by way of identifying users with relevant areas of expertise, for example. In most instances, reviewer selection is on a semi-random basis. In one embodiment, the reviewer generally does not get to choose the content to review.

Once reviewers have been selected and identified as willing to participate in the review process, the reviewer identifier module 206 communicates with the communications module 204 to provide content to the reviewers for rating and/or otherwise scoring. The communications module 204 can provide content to the reviewers via one or more of various communications protocols. For example, the communications module 204 can send the content to the reviewer via a wired and/or wireless network through email, messaging, http, text messages, etc. Once the reviewer has reviewed the content, the communications module 204 receives the rating, ranking, score, and/or any other indicator of content quality from the reviewer. The reviewer response can also be received via any known and/or convenient communications protocol. Reviewer responses/comments are in some embodiments, sent to the score processing module 208 for storage and/or additional processing and analysis.

One embodiment of the host server 200 includes a score processing module 208. The score processing module 208 can be any combination of software agents and/or hardware components able to receive reviewer responses related to content quality and/or to perform further processing/analysis on the quality indicators received from the reviewers. The score processing module 208 can, in some embodiments, record the received reviews for each content associated with the reviewer. Therefore, the score processing module 208 is able to compute cumulative ratings/scores for each piece of content that has been reviewed. Cumulative ratings can be determined in a number of known and/or convenient mathematical/statistical methods. For example, the mean and/or variance of the ratings/scores received for a particular piece of content can determine the cumulative rating.

Additional processing procedures may be performed including de-noising, removing outlying data points, additional statistical methods such as regression analysis, correlation determination, etc. Statistical data regarding cumulative scores content has received provides an estimate of the quality of the content and general popularity of the content. In some instances, individual scorings for a particular piece of content that fall outside of one or more variances of the mean score may be flagged for further action. For example, the meticulousness of the reviewer may be assumed to be lacking when the reviewer continuously assigns scores/ratings that are inconsistent with those granted by other reviewers. Reviewer ratings may be decreased if a reviewer is frequently assigning inconsistent scores compared to other reviewer users. In some embodiments, the score processing module communicates with the reviewer ranking module 214 to adjust reviewer ratings.

Statistical attributes for scores granted by each reviewer can also be determined. For example, the average and/or variance of scores granted by a reviewer over a predetermined amount of time. The average and/or variance of scores granted by a reviewer for a particular type of content and/or for content relating to a particular subject matter. Scoring patterns of individual reviewers can be determined from such data to normalize scoring scales between reviewers. For example, some reviewers may have a tendency to be more lenient with awarding scores than others. In one embodiment, the score processing module includes a statistics tracking module to perform one or more of the above described functionalities.

One embodiment of the host server 200 includes a timer module 210. The timer module 210 can be any combination of software agents and/or hardware components able to determine relative and/or absolute time. The timer module 210, in some embodiments, tracks the time elapsed. In addition, the timer module 210, in some embodiments, externally couples to a time server (e.g., World Time Server, NTP time server, U.S. Time server, etc.) to keep track of time. The timer module 210 may be accessed by the score processing module 208 and/or the review tracking module 212 to determine the amount of review time expended by a reviewer to rank a particular piece of content. For example, the score processing module 208 can track the time when content is accessed by a reviewer and the time when a score/rating is received from the reviewer. The time difference can be estimated to be the duration of time the reviewer took to generate a rating.

The timer module 210 may include additional functionality related to analyzing timing information related to tracking review time. The timer module 210 may be able to determine review time for a reviewer to rate a piece of content. Timing statistics may be computed on a per reviewer and/or on a per piece of content basis. For example, the average amount of take it takes a set of reviewers to review a particular piece of content may help determine whether another user spend too little time. The timer module 210 may include a statistics tracking module to perform one or more of the above functions.

In some embodiments, tracking of review time is performed by the review tracking module 214. The review tracking module 214, through communications with the communications module and the score processing module can determine when content is accessed by a reviewer and when a rating/score has been received from the reviewer. The review tracking module, in some embodiments, also tracks the review record of a reviewer. For example, the review tracking module 214 can keep track of the number of reviews received by a reviewer versus the total number of requests to determine reviewer responsiveness. Reviewer responsiveness is typically used for rating reviewers. The review tracking module 212 may communicate such information to the reviewer ranking module 214.

One embodiment of the host server 200 includes a reviewer ranking module 214. The reviewer ranking module 214 can be any combination of software agents and/or hardware components able to compile quantitative data and/or qualitative data regarding reliability of a user as a reviewer. The reviewer ranking module is able to communicate with the scoring module, timer module, and/or the review tracking module to receive and/or request information related to reviewer performance. Review time information can be received from the timing module and/or the review tracking module, for example. Further, data related to reviewer responsiveness can also be received, typically, from the review tracking module 212.

The reviewer ranking module 214 can, in some embodiments, generate one or more metrics to quantify a user's reliability as a reviewer as determined by, by way of example, but not limitation, responsiveness, consistency in responding when requested, meticulousness in reviewing content, review time expended, etc. One score can be generated to provide an overview of reviewer reliability. In other embodiments, a score can be generated to provide an indication of each metric (e.g., responsiveness, consistency, etc.).

One embodiment of the host server 200 includes a content publisher module 216. The content publisher module 216 can be any combination of software agents and/or hardware components able to publish content ranking or contents ranked above a certain threshold. The content publisher module 216 communicates with the score processing module 208 such that it possesses ranking and/or rating information related to content submissions. The content publisher module 216 can publish on a website, content that has received ratings over a predetermined threshold, for example, from a predetermined number of reviewers. The content publisher module 216 can also license rated content to third party content hosts for fixed or variable fees. In some embodiments, the content publisher module 216 provides a requester (e.g., end user, third party content host) the ranking/rating information of a set of content.

The host server 200 can be implemented using one or more processing units, such as server computers, UNIX workstations, personal computers, and/or other types of computes and processing devices. In the example of FIG. 2, the host server 200 includes multiple components coupled to one another and each component is illustrated as being individual and distinct. However, in some embodiments, some or all of the components, and/or the functions represented by each of the components can be combined in any convenient and/or known manner. For example, the components of the host server may be implemented on a single computer, multiple computers, and/or in a distributed fashion.

Thus, the components of the host server 200 are functional units that may be divided over multiple computers and/or processing units. Furthermore, the functions represented by the devices can be implemented individually or in any combination thereof, in hardware, software, or a combination of hardware and software. Different and additional hardware modules and/or software agents may be included in the host server 200 without deviating from the spirit of the disclosure.

FIG. 3A depicts a block diagram illustrating an example of a user database 328 that stores user profile information 328A, user content 328B, and reviewer ratings 328C, according to one embodiment.

In the example of FIG. 3A, the database 328A can store user profile data, including data related to user information and/or user subscription information. For example, user profile data can include descriptive data of personal information such as, but is not limited to, a first name and last name of the user, a valid email ID, a unique user name, age, occupation, location, membership information, topics of expertise, topics of interest, demographics, etc. User profile data may further include interest information, which may include, but is not limited to, activities, hobbies, photos, etc.

In one embodiment, user profile data stored in database 328A is explicitly submitted by the user. For example, when the user (e.g., visitor/service subscriber) subscribes for content reviewing services, a set of information may be required, such as a valid email address, an address of service, a valid credit card number, social security number, a username, and/or age, etc. The user information form can include optional entries, by way of example but not limitation, location, activity, hobbies, ethnicity, photos, etc.

The database 328 can also store user content and/or data related to information of user content (e.g., user content data/metadata), for example, in database 328B. User content and user content metadata can either be explicitly submitted by the user or provided via one or more software agents and/or hardware modules coupled to the database 328B. For example, a user can upload user content to be stored in database 328. The user content can include textual content, audio content, image content, video content, messages, and/or emails. User content can also be recorded over a network in real-time or near real-time and stored in the database 328B.

User content metadata can, in some instances, be automatically identified and stored in the database. In particular, content metadata include by way of example but not limitation, owner, author, topic, date created, date modified, genre, bit-rate, file size, tags, video quality, image quality, etc.

The database 328 can also store reviewer ratings, for example, in database 328C. The database 328C can store data used to compile/compute reviewer ratings. For example, scores granted to content by the reviewer can be stored. Comments by other users about the usefulness of the scores granted by the user can also be stored. Quantitative metrics such as, time to generate a score, average time to generate a score, response rate, and/or average response rate. Performance metrics can be submitted to the database 328C via one or more software agents and/or hardware modules coupled to the database 328. Additionally, performance metrics (e.g., qualitative comments) may be submitted by other users.

FIG. 3B depicts a block diagram illustrating an example of a content database 330 that receives submitted content, according to one embodiment.

Most newly submitted content is un-scored and can be stored, for example, in the database 330A. The un-scored content typically initially undergoes a first pass review process where the un-scored content is provided to a set of reviewers for review. A cumulative score/rating that determines whether the content becomes unpublished or if the content proceeds to receive a second pass review can be computed from the ratings/reviews received from the set of reviewers. If the cumulative rating is below a certain threshold, the content may be unpublished, and stored, for example, in database 330D. Unpublished content may eventually be discarded.

If the cumulative rating exceeds a certain threshold, the content may be reviewed a second time prior to publication or otherwise made available to a requester or reader. Content that is eligible to be reviewed a second time can be stored in the database 330C, for example. Once the content has been scored by an additional set of reviewers, another cumulative score can be computed. The cumulative score determines, in one embodiment, whether the content is published or unpublished. Content publication refers to one or more of, making the content's ranking/rating available to the public or a requester (e.g., individual user or a content host), making the content visible, providing the content to the public (e.g., searchable via a search engine) and/or the requester, etc.

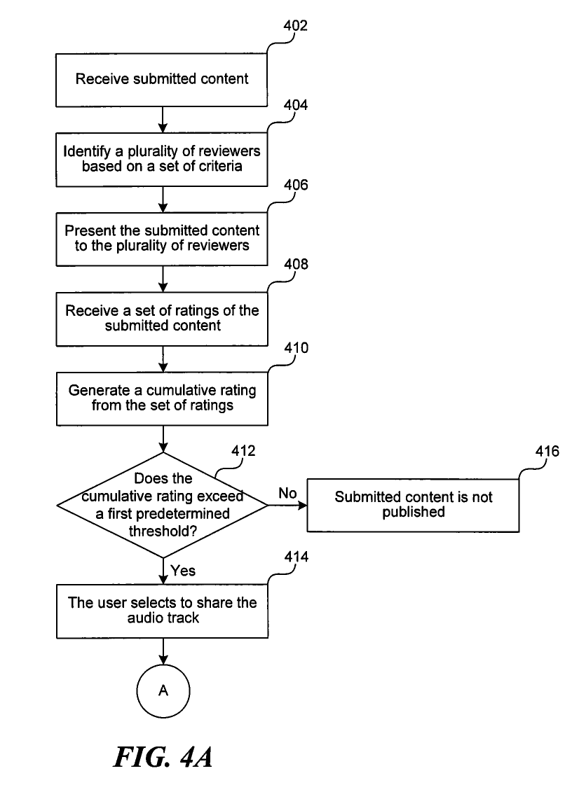

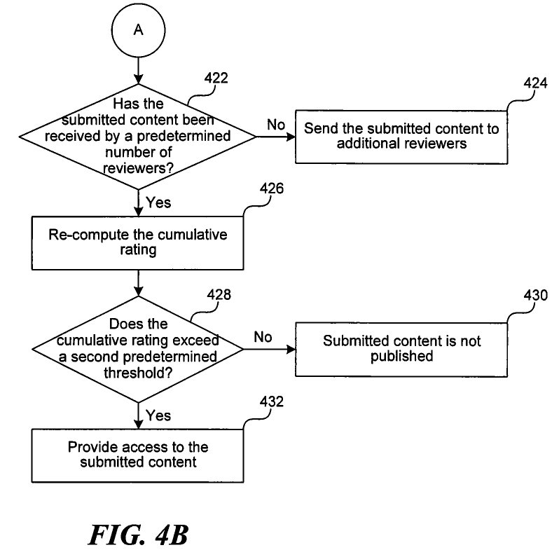

FIG. 4A depicts a flow diagram illustrating an example process of performing a first pass review to preliminarily screen the submitted content, according to one embodiment.

In process 402, submitted content is received. Content is typically user submitted and may be received from a number of sources. User submitted content can be received from users directly via form submission, uploading, messaging, and/or emailing, etc. User content is typically in a variety of formats. For example, user content can be an article, a comment, a posting, a blog, an image, a video (e.g., movies), an animation, a link to web-content, etc.

User submitted content can also be received from a third party content server (e.g., third party Internet site, community site, etc.). In some situations, third party content servers directly receive user submitted content for which they wish to perform quality control prior to publication on the website to other users. Therefore, the third party content server, can, in some instances, outsource a set of user submitted content for ranking purposes (e.g., rating or otherwise indicating quality).

Submitted content received for rating can be initially stored in a database. Submitted content can, in some embodiments, be analyzed to detect relevant subject matter. In some embodiments, content is organized and stored according to the subject matter and/or type of content, that is either explicitly specified (e.g., user specified) or system identified. The type of content and/or the subject matter relating to the content can assist the system in identifying reviewers from a set of users. For example, users may have specific areas of expertise related to a particular subject matter and can be identified as a potentially suitable reviewer to rate and article related to the particular subject matter.

User preferences for specific subject matter may be a factor in determining user suitability as a reviewer. Generally, reviewers are presented with content with a vast array of subject matter to promote objectivity in rankings and to prevent reviewer bias for content relating to preferred subject matter. Although reviewers will generally review content of preferred as well as less favorable subject matter, reviewers can be rewarded as well as incentivized by allowing the reviewer to specify content to be reviewed, for example, after the reviewer has reviewed a predetermined number of system selected content.

In process 404, a plurality of reviewers is identified based on a set of criteria. In one embodiment, the plurality of reviewers is identified such that five reviews can be obtained during the initial review pass.

The set of criteria is typically system determined based on a number of factors including, end user request (e.g., a subscriber user), customer request (e.g., end user and/or third party content sites), subject matter relating to the submitted content under review, time constraints related to requests, the number of reviews the content has received, etc.

For example, a customer may request that each piece of content is to be rated by at least 100 reviewers while another customer may request that each content be rated by 200 reviewers. Based on an estimated rate of responsiveness, the system may need to identify 150 reviewers in the first case and 300 reviewers in the second case. In another example when the relevant subject matter is highly specialized (e.g., nanotechnology, quantum mechanics, semantic web, etc.), the system may seek to identify users with relevant areas of expertise to ensure the preciseness and accuracy of the reviews.

In process 406, the submitted content is presented to the plurality of reviewers. The submitted content and/or links to the submitted content to be reviewed can be presented to the reviewer users upon logon to the host site. In some embodiments, the content is emailed to the reviewer users for email access. Similarly, notifications that new content is awaiting review can be sent to the user, for example, via email, instant messages, and/or other forms of messaging that may be user specifiable.

The submitted content to be reviewed is typically presented to a reviewer user with an interface mechanism for scoring the content, either qualitatively or quantitatively. For example, interface mechanism can include a graphical depiction of a numerical scale (e.g., a graphical sliding bar, a scroll bar, a selectable entry, etc.). The interface mechanism can include a text box for the user to manually enter a score between predetermined ranges. In some embodiments, the interface mechanism includes a set of predetermined criteria for rating the submitted content. For example, each criteria (e.g., clarity, depth, quality, image quality, writing style, video quality, etc.) can be rated by the reviewer on an independent scale. In some embodiments, rating criteria can be reviewer specified.

In process 408, a set of ratings of the submitted content is received. Ratings received for a piece of content from reviewers are stored for further processing. The processing can be performed continuously or after a predetermined number of ratings have been received. Multiple types of ratings for a particular piece of content may be tracked and recorded. For example, an article may be rated based on both its coherency and clarity.

In process 410, a cumulative rating is generated from the set of ratings for the submitted content. The cumulative rating can be an average of set of ratings. Other statistical manipulations (e.g., variance determination, chi-square, t-test, regression analysis, factor analysis, cross-auto-correlation analysis, etc.) of the set of ratings to generate a cumulative rating are contemplated and considered to be within the novel scope of this disclosure. Furthermore, additional data processing, analysis, mining, and/or de-noising can be performed in conjunction with or in addition to the process statistical analysis, for example.

In some instances, the cumulative rating can be weighted averages of the set of ratings. For example, ratings provided by experts of the subject matter may be weighted heavier. Similarly, cumulative ratings can encompass ratings for various criteria of the submitted content. For example, a piece of content can have a cumulative rating for video content and another rating for video quality. In some instances, various criteria may have different weights. For example, video content can be weighted heavier than video quality. In some instances, one cumulative rating can be generated for all the criteria used to rate a piece of content.

In process 412, it is determined if the cumulative rating exceeds a first predetermined threshold. The predetermined threshold may be user specified and/or system determined. Additionally, thresholds may be adaptive to the type of content, the number of reviews, and/or the subject matter of the content, for example. If the cumulative rating does not exceed the first predetermined threshold, the submitted content is not published, as in process 416. If the cumulative rating exceeds the first predetermined threshold, the submitted content is presented to an additional set of reviewers 414. The additional set of reviewers can be selected via a process similar thereto of that discussed in association with process 404. The content review process continues with further reference to FIG. 4B.

FIG. 4B depicts a flow diagram illustrating an example process of performing a second pass review to determine publication of the submitted content, according to one embodiment.

After the piece of content has passed a first round review session and received reasonable ratings from a number of reviewers, additional reviewers are selected to further review of the same piece of content. The content is presented to additional reviewers and ratings are received from at least a portion of the additional reviewers. The second pass ratings submitted by reviewers are tracked and recorded. In process 422, it is determined if the submitted content has been received by a predetermined number of reviewers. If not, in process 424, the submitted content is sent to additional reviewers. If so, in process 426, the cumulative rating is re-computed. The cumulative rating can be determined based on a process similar thereto of that discussed in FIG. 4A.

One criterion for publication or publication of ranking of the piece of content can include receiving a cumulative rating above a certain threshold when a predetermined number of reviewers have reviewed the content. The predetermined number of reviewers may be user specifiable, customer specifiable, adaptable, and/or different for varying types of content and content containing varying types of subject matter. For example, an article on quantum mechanics may require lesser reviewers than an article on tax deductions in part due to differences in popularity and in part due to general knowledge of the mass public and the ability of a reviewer to objectively rate the article based on a reasonable understanding.

In process 428, it is determined if the cumulative rating exceeds a second predetermined threshold. The second predetermined threshold may be determined from a process similar thereto of that described in conjunction with FIG. 4A. The second predetermined threshold may be substantially similar to, greater than, or lesser than the first predetermined threshold, as suitable, as determined by a default setting or on a case-by-case basis.

If the cumulative rating does not exceed the second predetermined threshold, in process 430, the submitted content is not published. If so, in process 432, access to the submitted content is provided. For example, the content may be published and be accessible to users in addition to reviewers. The content rating may be visible as well. In some embodiments, the ratings are provided to the third party reviewers whom requested rating of user submitted content. The ratings may be provided at a charge. In some embodiments, rated content is licensed out third party servers/sites for a fixed and/or adjustable fee.

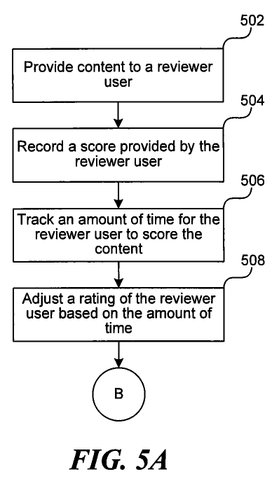

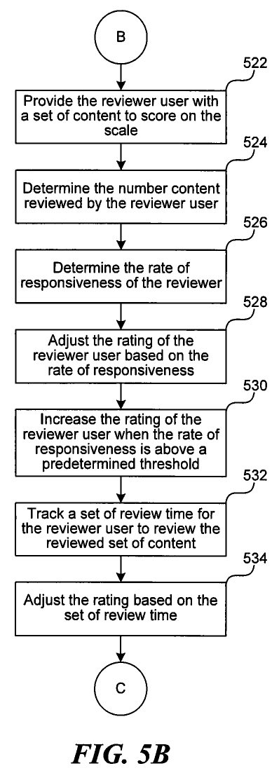

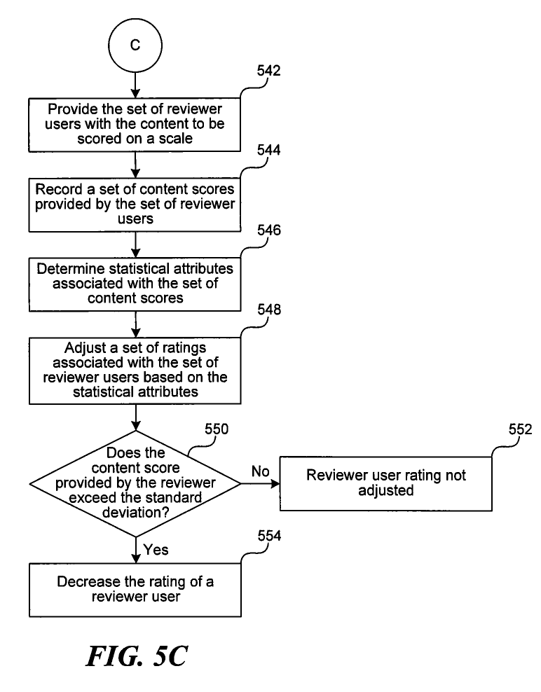

FIG. 5A depicts a flow diagram illustrating an example process of adjusting the rating of a reviewer user, according to one embodiment.

In process 502, content to be scored on a scale is provided to a reviewer user. The content can be provided via one or more of many delivery channels. In addition to providing access to the actual content, a notification can be provided to the reviewer user. Content and/or notifications can be displayed via a webpage, for example, upon logon. Additionally, content and/or notifications can be sent via email and/or via any other desktop delivery methods such as instant messages and/or pop-ups. Furthermore, content/notifications can be received via portable handheld devices via wired and/or wireless networks, for example, through text messages. In process 504, a score provided by the reviewer user is recorded. The reviewer user can submit a score via any known and/or convenient method.

The content may be provided to the reviewer user with an interface mechanism suitable for quantitative and/or qualitative rating/scoring. For example, the reviewer user can manipulate user interface components (e.g., scroll bars, slide bars, buttons, tabs, drop-down boxes, and/or a text box, etc.) to select and/or submit one or more ratings for the content. In some embodiments, reviewers can submit ratings without a specialized interface, for example, via email, messaging (instant), and/or otherwise text messaging.

In process 506, the amount of time for the reviewer user to score the content is tracked. In most instances, the time when the reviewer accesses the content to be reviewed is recorded. The time when a rating is submitted is typically also recorded. In one embodiment, the amount of time for the reviewer to score the content is estimated to be the difference in time between when a rating is submitted and when the user first accesses the content. The review time can be tracked as an indicator of the quality of user review. Since content review, especially, article review, is assumed to take some amount of time. If the reviewer user spends substantially less amount of time than the expected amount of review time reviewing content such as an article, the reviewer user rating may be decreased. In addition, the weightings given to the scores granted by the reviewer can also be decreased.

The expected review time can be estimated for different types of content. For example, articles, other textual documents, and/or videos typically have a larger expected review time. Images and audio content may have lesser expected review times compared to textual content and video content. Of course, adjustments can be made according to the length of the text document, video content, audio content, etc. In addition, expected review times can be computed from statistical analysis review time data collected from tracking reviewers' actual expended review times. For example, the average review time and/or standard deviation can be computed for different types and length of content. Content length can be determined from file size or physical size (e.g., length of article in number of pages, image size, etc.) that the content occupies.

In process 508, rating of the reviewer user is adjusted based on the amount of time the user took to score the content. If the reviewer user spends less time than expected, the reviewer rating may be decreased. If the reviewer user spends more time than expected, the reviewer rating may be increased or unchanged.

FIG. 5B depicts a flow diagram illustrating another example process of adjusting the rating of a reviewer user, according to one embodiment.

In process 522, the reviewer user is provided with a set of content to be scored on a scale. In process 524, the number of user reviewed content is determined. In general, reviewer users will review a portion of the content sent to them for review. Responsiveness of the reviewer is a metric to determine how reliable a reviewer is in terms of how likely they will review content provided to them. In process 526, the rate of responsiveness of the reviewer is determined. By recording the number of reviews received and the amount of content provided to the reviewer user, responsiveness can be estimated.

In process 528, the rating of the reviewer is adjusted based on the rate of responsiveness. Typically, a low response rate causes the reviewer rating to be decreased where as a high response rate can cause the reviewer rating to increase. In process 530, the rating of the reviewer user is increased when the rate of responsiveness is above a predetermined threshold. Response rate can be tracked over a period of time and may have an affect on reviewer rating when a low or high response rate persists beyond a predetermined amount of time. For example, a reviewer user may need to have a rate of response of >80% for over one week for the reviewer rating to increase. In some instances, a reviewer user may need to have a response rate that exceeds the threshold after having reviewed a certain amount of content.

In process 532, a set of review time for the reviewer user to review the content is tracked. In process 534, the rating is adjusted based on the review time in a similar fashion as that described in conjunction with FIG. 5B.

FIG. 5C depicts a flow diagram illustrating a further example process of adjusting the rating of a reviewer user, according to one embodiment.

In process 542, the set of reviewer users are provided with the content to be scored on a scale. In process 544, a set of content scores provided by the reviewer users are recorded. The set of content scores can be provided via one or more of many mechanisms similar thereto of those discussed in association with FIG. 5A. In process 546, statistical attributes associated with the set of content scores are determined. Various statistical analysis methods known and/or convenient can be performed on the aggregate set of content scores. In some embodiment, data processing, including but not limited to, data mining and de-noising procedures are performed on the dataset prior to statistical analysis. Statistical analysis performed can include, one or more of, Bayesian analysis, chi-square test, ANOVA test, mean computation, variance computation, factor analysis, and/or correlation determination, for example.

In process 548, ratings associated with the reviewer users are adjusted based on the statistical attributes. Generally, review provided by a reviewer user is frequently inconsistent (as determined from statistical attributes, e.g., outside one, two, or three standard deviations of the mean) with other users' ratings, the reviewer user rating may be decreased. Typically, a predetermined number of inconsistent reviews will cause the reviewer rating to decrease. A few standalone instances of inconsistent reviews may not affect the reviewer rating.

For example, in process 550, it is determined if the content score provided by the reviewer user exceeds the standard deviation of the set of content scores. If the content score does not exceed the standard deviation, the reviewer user rating is not adjusted, as in process 552. If the content score given by the reviewer user exceeds the standard deviation, the reviewer user rating is decreased, in process 554.

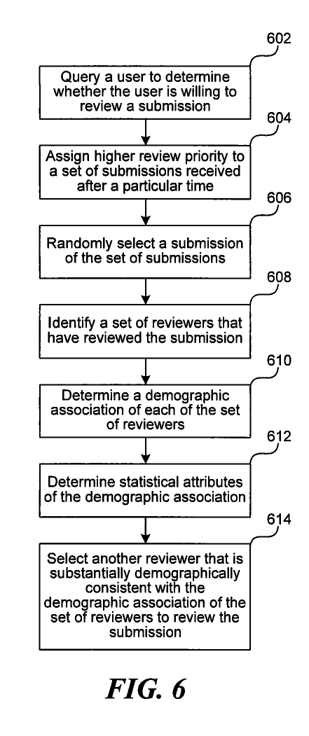

FIG. 6 depicts a flow diagram illustrating an example process of selecting a reviewer to rate a submission, according to one embodiment.

In process 602, a user is queried to determine willingness of the user to review a submission. When a user is web browsing, the user may be queried, for example, via a dialogue box asking whether the user is willing to review a submission for the purposes of rating. The system may query a number of users and provide indicators of willingness to rate submissions in the user profile for those that response affirmatively to the query. In some embodiments, the identity of a potential review is verified, for example through verifying validity of an email address submitted by the potential reviewer. Reviewer verification prevents users from using fraudulent identifies and software programs from intervening the reviewer selecting and content ranking process. Other verification methods include by way of example but not limitation, presenting non-machine readable code (e.g., Captcha) to a potential reviewer for interpretation.

Once the identity of a potential reviewer has been verified, the submission that is given to the reviewer for review is selected based on a number of factors. One factor includes, achieving timely ratings of submissions that have not been reviewed or newly submitted content. Therefore, content that has yet to receive a rating may be prioritized over content that have received some rating but insufficient to obtain statistical significance (e.g., content in the second pass review process). For example, if there is a shortage of reviewers, higher priority may be given to obtaining initial ratings (e.g., first pass review process) of new/unrated submissions and lower priority may be given to obtaining statistical significance of older/rated submissions.

In a further example, in process 604, higher review priority is assigned to a set of submissions received after a particular time, such that newer submissions have a higher review priority. Priority can also be assigned based on the number reviews a submission has received. In this instance, submissions with a number of ratings below a predetermined threshold receive higher rating than those with a number of ratings above the threshold.

In process 606, a submission is randomly selected from the set of submissions. In general, matching between a submission and a reviewer is a random process. The reviewer typically will not be able to predict the type of content and/or the related subject matter of the content to be reviewed for obtaining objectivity in the rating process. In addition, each reviewer typically reviews a submission once. For example, if the submission that is randomly selected has been reviewed or otherwise viewed by the reviewer, another submission may be chosen.

In process 608, reviewers that have reviewed the randomly selected submission are identified. In process 610, the demographic associations of the reviewers are determined. In one embodiment, demographic consistency of reviewers for a submission is maintained. In process 612, statistical attributes of the demographic association is determined. For example, the number and percentage of reviewers of each demographic can be determined. In process 614, another reviewer that is demographically consistent with the demographic associations of the reviewers is selected to review the submission. For example, if a large percentage of reviewers of the submission are females over the age of thirty-five, higher priority may be placed in locating another reviewer of a same/similar demographic.

In one embodiment, demographic consistency is also sought between submissions and their competing submissions. Therefore, in some instances, the demographic associations of a competing submission are also determined. Demographic consistency may be ensured by monitoring the times of day that submissions are reviewed by users since different user demographics tend to browse the web at different times of the day. In addition, demographic information gleaned from a user profile can be further utilized.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. § 112, ¶6, other aspects may likewise be embodied as a means-plus-function claim, or in other forms, such as being embodied in a computer-readable medium. (Any claims intended to be treated under 35 U.S.C. § 112, ¶6 will begin with the words “means for”.) Accordingly, the applicant reserves the right to add additional claims after filing the application to pursue such additional claim forms for other aspects of the disclosure.

What is claimed is:

1. A method of content review, the method, comprising:
receiving submitted content;
identifying a plurality of reviewers based on a set of criteria;
presenting the submitted content to the plurality of reviewers;
receiving a set of ratings of the submitted content from a set of the plurality of reviewers; and
generating a cumulative rating from the set of ratings.

2. The method of claim 1, wherein the set of criteria comprises, one or more of, ratings, topics of preference, and topics of expertise of a set of reviewers from which the plurality of reviewers is to be selected.

3. The method of claim 1, further comprising, determining whether the cumulative rating exceeds a first predetermined threshold.

4. The method of claim 3, further comprising, presenting the submitted content to an additional set of reviewers responsive to determining that the cumulative rating exceeds the first predetermined threshold.

5. The method of claim 3, further comprising:
determining that the submitted content has been received by a predetermined number of reviewers; wherein the predetermined number of reviewers is determined logarithmically;
re-computing the cumulative rating based on ratings submitted by the predetermined number of reviewers;
determining that the cumulative rating of the submitted content exceeds a second predetermined threshold; and
providing access to the submitted content.

6. The method of claim 1, further comprising, selecting the plurality of reviewers based on a ranking associated with each of the plurality of reviewers.

7. The method of claim 5, wherein the set of criteria includes the ranking associated with each of the plurality of reviewers.

8. The method of claim 4, further comprising, responsive to determining that a particular reviewer of the plurality of reviewers has rated a particular submitted content below the first predetermined threshold, presenting the particular reviewer with another submitted content having a cumulative rating above the first predetermined threshold.

9. The method of claim 1, wherein the submitted content comprises, at least one of, textual content, audio content, image content, and video content.

10. A method of rating a set of reviewer users, the method, comprising:
providing content to a reviewer user to be scored on a scale;
recording a score provided by the reviewer user;
tracking an amount of time for the reviewer user to score the content; and
adjusting a rating of the reviewer user based on the amount of time.

11. The method of claim 10, further comprising:
further providing the reviewer user with a set of content to score on the scale;
determining a rate of responsiveness of the reviewer user based on a number of a reviewed set of content reviewed and a number of a provided set of content;
recording a set of scores provided by the reviewer user associated with the reviewed set of content; and
adjusting the rating of the reviewer user based on the rate of responsiveness.

12. The method of claim 10, wherein, the rate of responsiveness is the ratio of the number of the reviewed set of content and the number of the provided set of content.

13. The method of claim 11, further comprising, increasing the rating of the reviewer user when the rate of responsiveness is above a predetermined threshold.

14. The method of claim 10, further comprising, tracking a set of review time for the reviewer user to review the reviewed set of content and adjusting the rating based on the set of review time.

15. The method of claim 10, further comprising:
providing the set of reviewer users with the content to be scored on a scale;
recording a set of content scores provided by the set of reviewer users associated with the content;
determining statistical attributes associated with the set of content scores; and
adjusting a set of ratings associated with the set of reviewer users based on the statistical attributes.

16. The method of claim 15, wherein, the statistical attributes comprises one or more of a mean and a standard deviation of the set of content scores.

17. The method of claim 16, further comprising, decreasing the rating of a reviewer user of the set of reviewer users when a content score of the set of content scores provided by reviewer user exceeds the standard deviation.

18. A method of selecting reviewers to rate a submission, the method, comprising:
querying a user to determine whether the user is willing to review a submission;
assigning higher review priority to a set of submissions received after a particular time;
randomly selecting a submission of the set of submissions;
identifying a set of reviewers that have reviewed the submission; and
determining a demographic association of each of the set of reviewers.

19. The method of claim 18, further comprising, determining statistical attributes of the demographic association of the set of reviewers.

20. The method of claim 19, further comprising, selecting another reviewer that is substantially demographically consistent with the demographic association of the set of reviewers to review the submission.

21. The method of claim 18, further comprising:
determining a subject matter for which the submission is relevant;
identifying an expert reviewer having expertise in the subject matter; and
presenting the expert reviewer with the submission to be reviewed.

22. A system, comprising:
a user database to store user information of a set of users;
a content database to store a plurality of content submissions;
a selection module to select a user from the set of users to review a particular content submission of the plurality of content submissions;
a review module to review the set of users; and
a ranking module to rank the plurality of content submissions based on user ratings submitted by the set of users.

23. The system of claim 22 further comprising, a timing module to determine an amount of time for the user to review the particular content submission.
